(19) United States
(12) Patent Application Publication
(10) Pub. No.: US 2019/0088053 A1
(43) Pub. Date: Mar. 21, 2019

(54) STORAGE DEVICE FOR SMART DEVICE, AND MANAGEMENT SYSTEM AND METHOD THEREFOR

(71) Applicants: Tae Hwa LEE, Goyang-si, Gyeonggi-do (KR); Seok Woo SON, Seoul (KR); Jin Pyo JUN, Seoul (KR); Kyung In OH, Namyangju-si, Gyeonggi-do (KR); ABKO CO. LTD., Seoul (KR)

(72) Inventors: Tae Hwa LEE, Goyang-si, Gyeonggi-do (KR); Seok Woo SON, Seoul (KR); Jin Pyo JUN, Seoul (KR); Kyung In OH, Namyangju-si, Gyeonggi-do (KR)

(21) Appl. No.: 16/082,419

(22) PCT Filed: May 11, 2017
(86) PCT No.: PCT/KR2017/004882

§ 371 Date: Sep. 5, 2018

(30) Foreign Application Priority Data
Jun. 17, 2016 (KR) 10-2016-0075861

(51) Int. Cl. G07C 9/00; B65D 85/00

(52) U.S. Cl. CPC G07C 9/00309; G07C 2009/00539; G07C 2009/00523; B65D 85/00

(57) ABSTRACT

A storage device for a smart device according to the present invention includes a storage unit configured to have multiple storage boxes for storing smart devices, a communication unit configured to receive, from a server, first control information which is information for selecting and controlling a storage box, an input unit configured to receive second control information which is information for selecting and controlling a storage box, a connection unit configured to have a port connected to a smart device in each storage box and charge the smart device, and a control unit configured to control unlocking of a corresponding storage box according to the first or second control information.

### TECHNICAL FIELD

The present invention relates to a storage device, a management system, and a management method for a smart device, and more particularly, to a storage device, a management system, and a management method for remotely controlling storage and management of multiple smart devices.

### BACKGROUND ART

Lately, various smart devices, including a smart phone, a smart pad, a smart watch, and a tablet personal computer (PC), have come into use. Since various kinds of applications can be arbitrarily installed, these smart devices provide various functions including Internet searching, document processing, and playing multimedia content. In particular, these smart devices are publicly used in various institutions and organizations, thus contributing to improvement of achievement in each field, such as various industries, education, and service.

However, smart devices which are publicly used in institutions and organizations are distributed to various branch offices in many cases. Therefore, it is difficult to manage the smart devices in one place, and it is inconvenient for a manager to manually perform management, such as installation of applications, upload of data files, and setting of an environment, for each smart device.

### PRIOR ART LITERATURE

(Patent Literature) Korean Patent No. 10-1546932 B1

### DISCLOSURE

### Technical Problem

To solve the above-described problems of conventional art, the present invention is directed to providing a storage device for remotely controlling storage and management of multiple smart devices, and a system and method for managing the multiple smart devices.

### Technical Solution

One aspect of the present invention provides a storage device for a smart device including (1) a storage unit having multiple storage boxes configured to store smart devices, each storage box being formed as a drawer type which is opened or closed in a sliding manner or a door type having a door which is opened or closed therein, (2) a communication unit configured to receive, from a server, first control information for selecting a specific storage box and controlling unlocking of the selected storage box and first synchronization configuration information containing information for selecting a specific storage box and synchronizing a smart device stored in the selected storage box, and configured to transmit current retaining status information generated by a control unit to the server, (3) an input unit configured to receive second control information for selecting a specific storage box and controlling unlocking of the selected storage box and second synchronization configuration information containing information for selecting a specific storage box and synchronizing a smart device stored in the selected storage box, (4) a connection unit configured to be connected to smart devices by having a port connected to a smart device in each storage box and configured to transfer a signal for charging or synchronizing the smart devices to the smart devices through ports, (5) a locking unit configured to lock or unlock the storage boxes, (6) a sensing unit configured to sense a locked state or an unlocked state of the storage boxes, and (7) a control unit configured to control the locking unit according to the first or second control information so that the corresponding storage box may be unlocked, to control the connection unit according to the first or second synchronization configuration information so that a smart device connected to a port of the corresponding storage box may be synchronized, and to generate current retaining status information representing whether each storage box stores a smart device or is empty because a smart device has been taken out.

Another aspect of the present invention provides a management method for a smart device, the method including (1) an information receiving operation of transmitting first control information for selecting a specific storage device and a specific storage box and controlling unlocking of the selected storage box of the selected storage device from a server to the storage device or receiving second control information for selecting a specific storage box and controlling unlocking of the selected storage box through an input unit and of transmitting first synchronization configuration information for selecting a specific storage device and a specific storage box and synchronizing a smart device stored in the selected storage box of the selected storage device from the server to the storage device or receiving second synchronization configuration information for selecting a specific storage box and synchronizing a smart device stored in the selected storage box through the input unit, (2) a control operation in which a control unit controls a locking unit according to the first or second control information so that a corresponding storage box is unlocked, and the control unit controls a connection unit to synchronize a smart device connected to a port of the corresponding storage box according to the first or second synchronization configuration information, (3) a generation operation in which the control unit generates current retaining status information representing whether each storage box stores a smart device or is empty because a smart device has been taken out according to a locked state or an unlocked state of the storage box sensed by a sensing unit, and (4) a transmission operation of transmitting the generated current retaining status information to the server through a communication unit.

### Advantageous Effects

The storage device, management system, and management method for a smart device configured as described above according to embodiments of the present invention make it possible to control the storage device, perform synchronization, and provide current retaining status information or synchronization result information depending on storage boxes of the storage device. Therefore, it is possible to easily store and manage multiple smart devices in a remote place.

### DESCRIPTION OF DRAWINGS

FIG. 1 is a block diagram of a management system for a smart device according to an embodiment of the present invention.

FIG. 2 is a front view of a storage device for a smart device according to an embodiment of the present invention.

FIG. 3 shows any one storage box configured as a drawer type in a storage device for a smart device according to an embodiment of the present invention.

FIG. 4 shows a drawer of any one storage box configured as a drawer type and a locking unit fastened to the drawer in a storage device for a smart device according to an embodiment of the present invention.

FIG. 5 shows a first embodiment of a data flowchart for synchronization performed by a management system for a smart device according to an embodiment of the present invention.

FIG. 6 shows a second embodiment of a data flowchart for synchronization performed by a management system for a smart device according to an embodiment of the present invention.

FIGS. 7 to 9 show a set-up program 50 of a management system 1 for a smart device according to an embodiment of the present invention.

### MODES OF THE INVENTION

Advantages and feature of the present invention and methods for achieving them will be apparent from embodiments described in detail below in conjunction with the accompanying drawings. However, the present invention is not limited to the embodiments disclosed below and will be embodied in many different forms. These embodiments are only provided to make the disclosure complete and aid those of ordinary skill in the technical field to which the present invention pertains in fully understanding the scope of the invention, and the present invention is only defined by the scope of the claims. Like reference numerals refer to like elements throughout the specification.

The terminology used herein is for the purpose of describing the embodiments only and is not intended to be limiting of the present invention. As used herein, the singular forms are intended to include the plural forms as well unless the context clearly indicates otherwise. The terms “comprises” and/or “comprising” when used in this specification specify the presence or addition of stated elements, steps, operations, and/or devices but do not preclude the presence or addition of one or more other elements, steps, operations, and/or devices. Unless otherwise defined, all terms used herein (including technical and scientific terms) have the same meaning as commonly understood by those of ordinary skill in the art to which the present invention pertains. It will be further understood that terms, such as those defined in commonly used dictionaries, will not be interpreted in an ideal or excessively formal sense unless clearly defined herein.

Hereinafter, exemplary embodiments of the present invention will be described in detail with reference to the accompanying drawings.

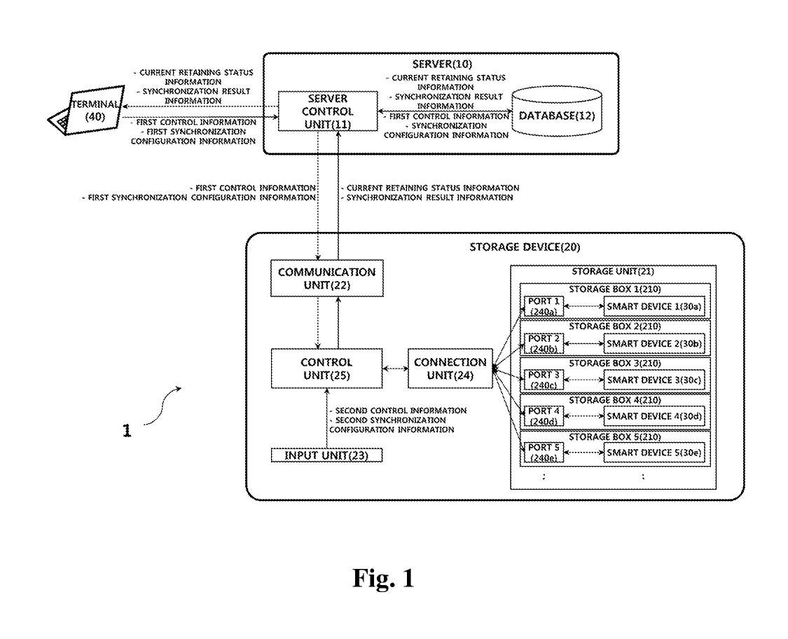

FIG. 1 is a block diagram of a management system 1 for a smart device according to an embodiment of the present invention.

The management system 1 for a smart device according to an embodiment of the present invention may include a server 10, a storage device 20, and smart devices 30 as shown in FIG. 1.

The server 10 transmits first control information or first synchronization configuration information to the storage device 20 and receives current retaining status information or synchronization result information from the storage device 20. Specifically, the server 10 may include a server control unit 11 and a database 12 as shown in FIG. 1 and may further include a communication unit besides.

The communication unit (not shown) is a component that exchanges various kinds of information (first control information, first synchronization configuration information, current retaining status information, synchronization result information, etc.) with the storage device 20 and may include a wired communication module or a wireless communication module. For example, the communication unit may include a mobile communication module, a wireless fidelity (WiFi) transceiver module, a Bluetooth transceiver module, a near field communication (NFC) module, a body area network (BAN) transceiver module, a ZigBee transceiver module, an Internet of things (IoT) transceiver module, and other short-range communication transceiver modules.

The server control unit 11 sets first control information or first synchronization configuration information according to a set-up program and performs control so that the set first control information or first synchronization configuration information may be transmitted to the storage device through the communication unit. In this case, the server control unit 11 may perform control so that the first control information or the first synchronization configuration information may be stored in the database 12. Also, the server control unit 11 performs control so that the current retaining status information or the synchronization result information received from the storage device 20 may be stored in the database 12 and performs control so that the current retaining status information or the synchronization result information stored in the database 12 may be processed and provided to a terminal 40 connected to the server 10 in the form of statistical data or a report. For example, the server control unit 11 may provide statistical data or a report of current retaining status information or synchronization result information to the terminal 40 by storage device, storage unit, port, or smart device.

The database 12 stores various kinds of information including the first control information and the first synchronization configuration information set by the server control unit 11 and the current retaining status information and the synchronization result information received from the storage device 20.

The first control information and the first synchronization configuration information transmitted from the server 10 to the storage device 20, the current retaining status information and synchronization configuration information transmitted from the storage device 20 to the server 10, and the set-up program executed by the server control unit 11 will be described in detail below.

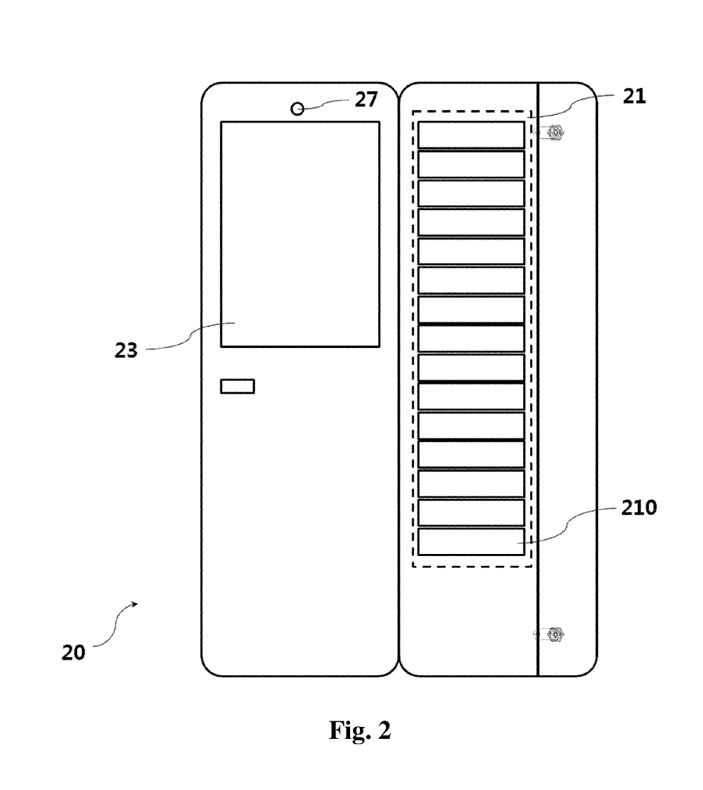

FIG. 2 is a front view of a storage device 20 for a smart device according to an embodiment of the present invention.

The storage device 20 stores multiple smart devices, and at least one storage device 20 may be provided. Here, each storage device 20 has its own unique identification information. Identification information of the storage device 20 will be referred to as “first identification information” below.

Specifically, the storage device 20 may include a storage unit 21, a communication unit 22, an input unit 23, a connection unit 24, and a control unit 25 as shown in FIG. 1. Here, the storage device 20 may be designed as a rectangular cabinet whose front door is opened or closed, and casters may be provided under the bottom. Also, a handle is provided on a side surface of the storage device 20 so that the storage device 20 can be moved, and a locking device may be installed on the front door so that the front door may not be arbitrarily opened or closed by a disallowed user.

The storage unit 21 has multiple storage boxes 210 for storing the smart devices 30. Each storage box 210 has an accommodation space to store one or more smart devices 30. Here, each storage box 210 may be configured as a drawer type which is opened or closed in a sliding manner or as a door type having a door which is opened or closed therein. Each storage box 210 has its own unique identification information. Identification information of each storage box 210 will be referred to as “second identification information” below.

The storage devices 20 according to an embodiment of the present invention may further include a locking unit (not shown) and a sensing unit (not shown). The locking unit is composed of a locking device which locks or unlocks each storage box 210 of the storage unit 21. Preferably, the locking unit is configured as an electronic type which usually maintains a locked state of a storage box 210 and unlocks a storage box 210 only when an unlock signal is received by the control unit 25. For example, when the storage boxes 210 are configured as the door type, the locking unit maintains a locked state of the doors upon the closing of the doors and unlocks the doors upon the receiving of an unlock signal by the control unit 25. Also, when the storage boxes 210 are configured as the drawer type, the locking unit maintains a locked state of the drawers upon the closing of the drawers and unlocks the drawers upon the receiving of an unlock signal by the control unit 25. The locking unit may include an electronic solenoid valve. In this case, when the control unit 25 receives an unlock signal, an electronic solenoid moves a position of the valve, thereby unlocking the doors or drawers of the storage boxes 210.

The sensing unit is a component that senses whether each storage box 210 is placed in the locked state or unlocked state by the locking unit. For example, when the locking unit includes an electronic solenoid valve, the sensing unit senses the locked state of the storage boxes 210 by sensing a signal generated by the electronic solenoid valve according to movement of the valve or a signal generated by a sensor, which comes in contact with the valve when the valve is at a specific position, according to whether the sensor comes in contact with the valve, and the sensed signal is transferred to the control unit 25.

A case in which the storage boxes 210 are configured as the drawer type will be described in further detail below.

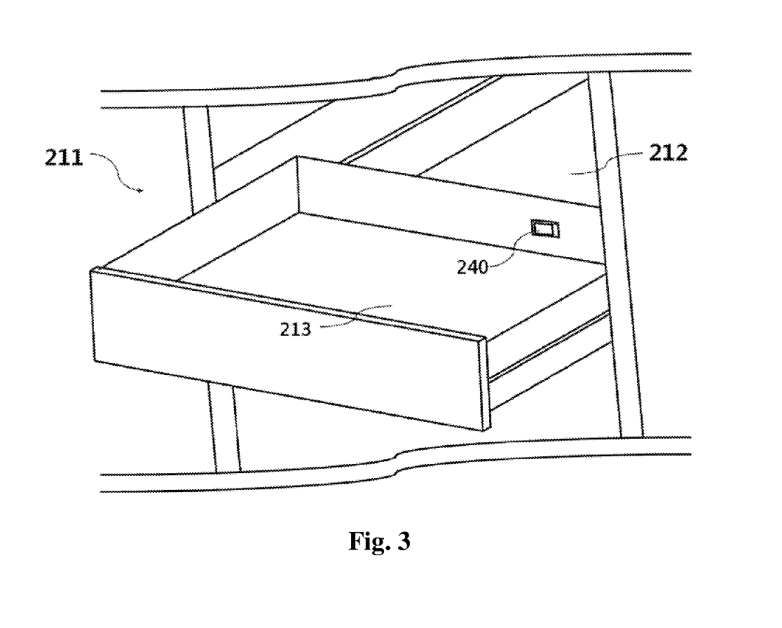

FIG. 3 shows any one storage box 210 configured as the drawer type in the storage device 20 for a smart device according to an embodiment of the present invention.

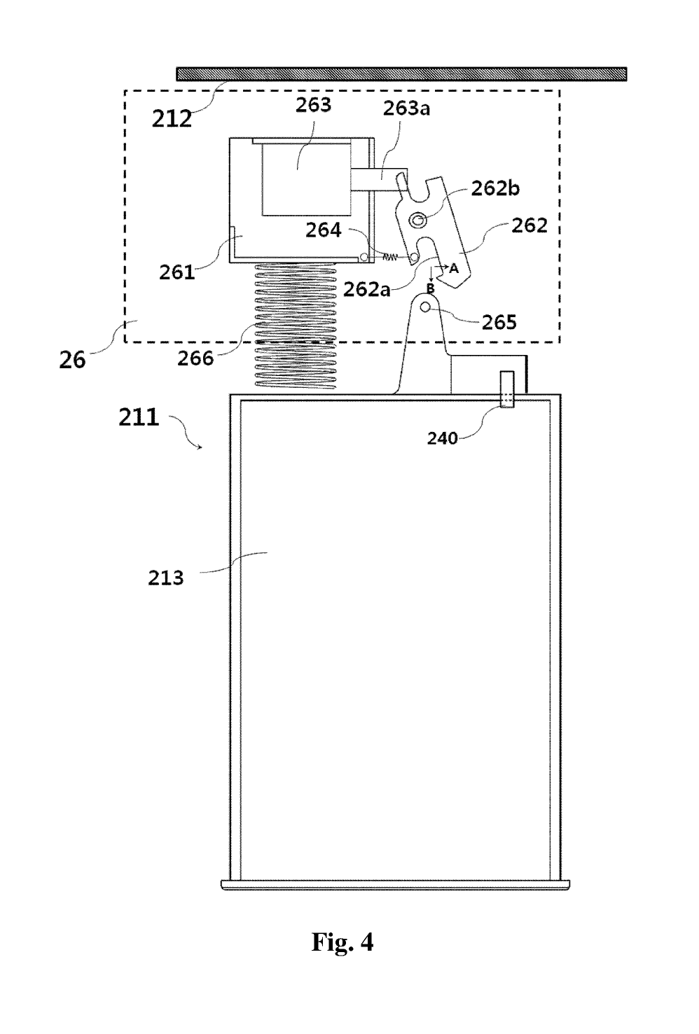

FIG. 4 shows a drawer 211 of any one storage box 210 configured as the drawer type and a locking unit 26 fastened to the drawer 211 in the storage device 20 for a smart device according to an embodiment of the present invention.

The storage box 210 may be configured as the drawer type as shown in FIG. 3. Here, the storage box 210 includes the drawer 211 which has an accommodation space 213 for accommodating a smart device 30 and is pushed in or pulled out in a sliding manner, and a body 212 which has a hollowed-out space that the drawer 211 is pushed in or pulled out from. As shown in FIG. 4, the locking unit 26 includes a bracket 261, a latch 262, a solenoid valve 263, a first spring 264, a hooking shaft 265, and a second spring 266.

The bracket 261 is installed in a rear side of the body 212. The latch 262 has a hooking recess 262a formed on one side, and a hinge 262b capable of rotation is provided on one side of the bracket 261. Here, a rear end of the latch 262 is coupled to a plunger 263a of the solenoid valve 263 fixed on the side of the bracket 261, and a front end of the latch 262 is connected to the first spring 264 so that a rotary force is applied in a direction in which the latch 262 is rotated back about a hinge shaft 262b. Meanwhile, the hooking shaft 265 around which the hooking recess 262a of the latch 262 is hooked is installed behind the drawer 211, and the second spring 266 which pushes out the drawer 211 released from the latch 262 is installed on a front side of the bracket 261. When an unlock signal is received by the locking unit 26 configured as described above from the control unit 25, the drawer 211 is unlocked and opened. When a user pushes the drawer 211 after the drawer 211 is opened, the drawer 211 is pushed in the body 212 and locked again by the locking unit 26 in the storage box 210.

A process in which the drawer 211 is locked and unlocked will be described in detail. When the unlocked drawer 211 is pushed in the body 212, the hooking shaft 265 behind the drawer 211 is kept hooked by the hooking recess 262a of the latch 262, and the drawer 211 is locked at the same time. When an unlock signal is received from the control unit 25 in this situation, power is applied to the solenoid valve 263, and the plunger 263a draws the rear end of the latch 262 such that the latch 262 is rotated by a certain range in an arrow direction A. Accordingly, the hooking shaft 265 is unlocked from the hooking recess 262a of the latch 262. At the same time, the drawer 211 is pushed in an arrow direction B by a restoring force of the second spring 266, unlocked, and opened. At this time, the latch 262 is returned to its original position due to a restoring force of the first spring 264.

The communication unit 22 is a component that exchanges various kinds of information (first control information, first synchronization configuration information, current retaining status information, synchronization result information, etc.) with the server 10 and may include a wired communication module or a wireless communication module. For example, the communication unit 22 may include a mobile communication module, a WiFi transceiver module, a Bluetooth transceiver module, an NFC module, a BAN transceiver module, a ZigBee transceiver module, an IoT transceiver module, and other short-range communication transceiver modules.

The input unit 23 is a component to which second control information or second synchronization configuration is input. The input unit 23 may be implemented in a switch type, a button type, or a display panel type which has a touch screen panel and thus is capable of recognizing a touch. When the input unit 23 is implemented as a display panel having a touch screen panel, the input unit 23 simultaneously serves as an output unit which outputs various kinds of information. Here, when a user touches a predetermined position on the display panel or inputs a predetermined pattern (e.g., a double click or drawing of a figure), the input unit 23 senses the corresponding touch operation and receives second control information or second synchronization configuration information. For example, the display panel may be configured as any one of a non-light-emitting display panel and a light-emitting display panel.

The non-light-emitting display panel is an image display device that uses a light modulation device for modulating light emitted from an external light source (sunlight, indoor light, backlight, or front light) according to an input signal. The non-light-emitting display panel is classified as a reflective type with a reflection means or a transmissive type without a reflection means. A liquid crystal display panel represents a transmissive panel among non-light-emitting display panels. Here, any one of light emitting diode (LED), a laser diode (LD), an organic light emitting diode (OLED), and a quantum dot light emitting diode (QLED) may be used as an external light source, but the external light source is not limited thereto. Among non-light-emitting display panels, a reflective panel may be any one of an electrophoretic display panel, a cholesteric liquid crystal display panel, a micro-electromechanical system display panel, an electrowetting display panel, and an electromagnetic fluid display panel, but a reflective panel is not limited thereto.

The light emitting display panel is an image display device that uses a light emitting device for modulating and emitting light according to an input signal by itself without any external light source. The light emitting display panel may be any one of a light emitting diode display panel, an organic electroluminescence display panel (or an OLED panel), a backlight liquid crystal display panel, and a quantum dot display panel, but the light emitting display panel is not limited thereto.

Second control information and second synchronization configuration information input to the input unit 23 will be described in detail below.

The connection unit 24 is an interface device which is connected to multiple smart devices 30, charges the smart devices 30, and performs data communication with the smart devices 30. In other words, the connection unit 24 transfers a signal for charging or synchronizing the smart devices 30 to the smart devices 30 through ports 240. For example, the connection unit 24 may be a universal serial bus (USB) interface but is not limited thereto. The connection unit 24 has a plurality of ports 240 which are parts directly connected to the smart devices 30. Here, each storage box 210 of the storage unit 21 may have one or more ports 240 in an accommodation space thereof. Accordingly, the smart devices 30 may be charged and perform data communication through the ports 240 while stored in the storage boxes 210. In particular, each port 240 has its own unique identification information. Identification information of each port 240 will be referred to as “third identification information” below.

For example, when the connection unit 24 is a USB interface, the USB interface may be composed of a USB connector formed at one end of a cable of the USB interface and a USB port formed to be put in a USB connector. The USB interface including the USB connector and the USB port may vary according to a shape, the number of pins, and the like. For example, the USB interface may be a standard A type, a standard B type, a mini A type, a mini B type, a micro A type, a micro B type, and the like.

The control unit 25 selects a storage box 210 of the storage unit 21 according to first control information received from the server 10 or second control information input from the input unit 23 and controls unlocking. Also, the control unit 25 may select a smart device 30 among smart devices 30 connected to the connection unit 24 according to first synchronization configuration information received from the server 10 or second synchronization configuration information input from the input unit 23 and perform control so that the selected smart device 30 may be synchronized. Also, the control unit 25 may generate current retaining status information and synchronization result information. Here, the control unit 25 performs control so that the generated current retaining status information and synchronization result information may be transmitted to the server 10 through the communication unit 22.

The storage device 20 may further include a retaining unit (not shown) for storing various kinds of information including first control information, second control information, first synchronization configuration information, second synchronization configuration information, current retaining status information, synchronization result information, first identification information, second identification information, third identification information, fourth identification information, and the like. The retaining unit may be implemented as a read-only memory (ROM), a random access memory (RAM), a flash memory, a magnetic tape, a floppy disk, an optical recording medium, and the like.

As shown in FIG. 2, the storage device 20 may further include an imaging unit 27. The imaging unit 27 is a component for filming a user of a storage box 210. When a smart device 30 is stored in or taken out from a storage box 210, the control unit 25 controls the imaging unit 27 to capture an image.

A smart device 30 is a portable terminal. A smart device 30 may be any one of a cellular phone, a smart phone, a smart pad, a smart watch, and a tablet PC but is not limited thereto. Here, each smart device 30 may have its own unique identification information. Identification information of a smart device 30 will be referred to as “fourth identification information” below.

In the management system 1 for a smart device according to an embodiment of the present invention, the server 10 may set first control information or first synchronization configuration information by itself, or as shown in FIG. 1, it is possible to set first control information or first synchronization configuration information through the terminal 40 capable of accessing the server.

First control information, second control information, first synchronization configuration information, second synchronization configuration information, current retaining status information, and synchronization result information will be described in detail below.

First, first control information is described. First control information is information set by the server 10 and includes information that is required for the storage device 20 receiving the first control information to control unlocking of each storage box 210 of the storage unit 21. In other words, first control information is information that separately contains a target of control and the content of control and may include control-purposed storage selection information, control-purposed first storage box selection information, and control-purposed first command information.

The control-purposed storage selection information contains information about which one of multiple storage devices 20 will be selected and includes first identification information of a storage device 20 selected for control.

The control-purposed first storage box selection information contains information about which one of multiple storage boxes 210 will be selected and includes second identification information of a storage box 210 selected for control.

The control-purposed first command information contains information that commands storage or removal of a smart device 30.

When first control information is received through the communication unit 22, the control unit 25 determines whether first identification information included in storage selection information of the first control information coincides with first identification information stored in the retaining unit. When the first identification information included in the storage selection information of the first control information coincides with the first identification information stored in the retaining unit, the control unit 25 controls the locking unit so that a storage box corresponding to control-purposed first storage box control information may be unlocked.

For example, when first control information, in which control-purposed storage selection information, control-purposed first storage box selection information, and control-purposed first command information are respectively [1031], [2014], and [storage], is received by the communication unit 22 of a storage device 20 having first identification information of [1031], the first identification information “1031” stored in the retaining unit coincides with the first identification information [1031] included in the control-purposed storage selection information. Therefore, the control unit 25 controls the locking unit to unlock a storage box 210 having second identification information of [2014] so that a smart device 30 may be stored in [2014] storage box 210.

When first control information, in which control-purposed storage selection information, control-purposed first storage box selection information, and control-purposed first command information are respectively [1031], [2015], and [take out], is received by the communication unit 22 of the same storage device 20, the first identification information [1031] stored in the retaining unit coincides with the first identification information [1031] included in the control-purposed storage selection information. Therefore, the control unit 25 controls the locking unit to unlock a storage box 210 having second identification information of [2015] so that a smart device 30 may be taken out from [2015] storage box 210.

Next, second control information is described. Second control information is information input from the input unit 23 and includes information required to control unlocking of each storage box 210 of the storage unit 21. In other words, second control information is information that separately contains a target of control and the content of control and may include control-purposed second storage box selection information and control-purposed second command information. Since the second control information is directly input through a storage device 20, control-purposed storage selection information included in first control information is unnecessary.

The control-purposed second storage selection information is information indicating which one of multiple storage boxes 210 will be selected and includes second identification information of a storage box 210 selected for control. Also, the control-purposed second command information contains information that commands to storage or removal of a smart device 30.

When second control information is received through the input unit 23, the control unit 25 controls the locking unit so that a storage box corresponding to control-purposed second storage box control information may be unlocked.

For example, when second control information, in which control-purposed second storage box selection information and control-purposed second command information are respectively [2016] and [storage], is input to the input unit 23 of a storage device 20, the control unit 25 controls the locking unit to unlock a storage box 210 having second identification information of [2016] so that a smart device 30 may be stored in [2016] storage box 210.

Also, when second control information, in which control-purposed second storage box selection information and control-purposed second command information are respectively [2017] and [take out], is received by the input unit 23 of a storage device 20, the control unit 25 controls the locking unit to unlock a storage box 210 having second identification information of [2017] so that a smart device 30 may be taken out from [2017] storage box 210.

Next, current retaining status information is described. Current retaining status information is information generated by the control unit 25 of a storage device 20 and represents current utilization status of each storage box 210 of the storage unit 21. In other words, current retaining status information represents whether each storage box of each storage device stores a smart device or is empty because a smart device has been taken out and includes current storage status information, current storage box status information, and retaining-removal information.

The current storage status information is information that contains first identification information of a storage device. In other words, the current storage status information indicates one of multiple storage devices 20. The current storage box status information is information that contains second identification information of each storage box 210. In other words, the current storage box status information indicates one of multiple storage boxes 210. The retaining-removal information represents whether a storage box 210 stores a smart device 30 or is empty because a smart device 30 has been taken out.

For example, when the control unit 25 generates current retaining status information in which current storage status information, current storage box status information, and retaining-removal information are respectively [1032], [2020], and [storage], the current retaining status information represents that a smart device 30 is stored in a storage box 210 having second identification information of [2020] in a storage device 20 having first identification information of [1032].

Also, when the control unit 25 generates current retaining status information in which current storage status information, current storage box status information, and retaining-removal information are respectively [1033], [2021], and [take out], the current retaining status information represents that a smart device 30 has been taken out from a storage box 210 having second identification information of [2021] in a storage device 20 having first identification information of [1033] and thus the storage box 210 is empty.

Meanwhile, when first control information including control-purposed first command information that commands storage of a smart device 30 is received by the communication unit 22, the control unit 25 controls the locking unit so that a corresponding storage box 210 may be unlocked. Subsequently, when the corresponding storage box 210 is placed in the locked state again and the sensing unit senses the locked state, the control unit 25 generates retaining status information indicating that a smart device 30 is stored in the corresponding storage box 210.

When first control information including control-purposed first command information that commands removal of a smart device 30 is received by the communication unit 22, the control unit 25 controls the locking unit so that a corresponding storage box 210 may be unlocked. Subsequently, when the corresponding storage box 210 is placed in the locked state again and the sensing unit senses the locked state, the control unit 25 generates retaining status information indicating that a smart device has been taken out from the corresponding storage box 210.

When second control information including control-purposed second command information that commands storage of a smart device 30 is input to the input unit 23, the control unit 25 controls the locking unit so that a corresponding storage box 210 is unlocked. Subsequently, when the corresponding storage box 210 is placed in the locked state again and the sensing unit senses the locked state, the control unit 25 generates retaining status information indicating that a smart device 30 is stored in the corresponding storage box 210.

When second control information including control-purposed second command information that commands removal of a smart device 30 is input to the input unit 23, the control unit 25 controls the locking unit so that a corresponding storage box 210 may be unlocked. Subsequently, when the corresponding storage box 210 is placed in the locked state again and the sensing unit senses the locked state, the control unit 25 generates retaining status information indicating that a smart device 30 has been taken out from the corresponding storage box 210.

Meanwhile, retaining status information may further include charge information, error information, or image information.

The connection unit 24 receives charge information that contains information about charge status from a smart device 30 connected to a port 241 of each storage box 210, and the control unit 25 generates retaining status information including the received charge information.

For example, when current retaining status information, in which current storage status information, current storage box status information, retaining-removal information, and charge information are respectively [1040], [2030], [storage], and [70], is generated by the control unit 25, the current retaining status information represents that a smart device 30 is stored in a storage box 210 having second identification information of [2030] in a storage device 20 having first identification information of [1040] and the corresponding smart device 30 is charged up to 70%.

When no charge information is received by the connection unit 24 or a charge value according to charge information received by the connection unit 24 is maintained within a certain range for a certain time period, the control unit 25 generates current retaining status information including error information which represents an error state of a storage box 210 of a corresponding port 241.

For example, a smart device 30 may be stored in a storage box 210 having second identification information of [2031] in a storage device 20 having first identification information of [1041]. When the connection unit 24 receives no charge information from the smart device 30, the control unit 25 may generate current retaining status information in which current storage status information, current storage box status information, retaining-removal information, and error information are [1041], [2031], [storage], and [error], respectively.

Also, a smart device 30 may be stored in a storage box 210 having second identification information of [2032] in a storage device 20 having first identification information of [1042]. When charge information received by the connection unit 24 from the corresponding smart device 30 is [80] for 5 minutes, the control unit 25 may generate current retaining status information in which current storage status information, current storage box status information, retaining-removal information, and error information are [1042], [2032], [storage], and [error], respectively.

When a smart device 30 is stored in or taken out from a storage box 210, the control unit 25 may control the imaging unit to capture an image. At this time, the control unit 25 generates current retaining status information including image information acquired by the imaging unit.

Next, first synchronization configuration information is described. First synchronization configuration information is information set by the server 10 and includes information required for a storage device 20 receiving it to perform synchronization. In other words, first synchronization configuration information is information that separately contains a target of synchronization and content of synchronization and may include first selection information and first content information.

Here, the first selection information contains information about which one of smart devices 30 stored in multiple storage boxes 210 of multiple storage devices 20 will be synchronized. In particular, each piece of first synchronization configuration information may have its own unique identification information. Identification information of first synchronization configuration information will be referred to as “fifth identification information” below.

Specifically, the first selection information may include synchronization-purposed storage selection information, synchronization-purposed first storage box selection information, first port selection information, first smart device selection information, and first reservation time information. Here, the first selection information may include any one or more of synchronization-purposed first storage box selection information, first port selection information, and first smart device selection information.

The synchronization-purposed storage selection information contains information about which one of multiple storage devices 20 will be selected and includes first identification information of a storage device 20 selected for synchronization.

The synchronization-purposed first storage box selection information contains information about which one of multiple storage boxes 210 will be selected and includes second identification information of a storage box 210 selected for synchronization.

The first port selection information contains information about which one of multiple ports 240 will be selected and includes third identification information of a port 240 selected for synchronization.

The first smart device selection information contains information about which one of multiple smart devices 30 will be selected and includes fourth identification information of a smart device 30 selected for synchronization.

The first reservation time information is information about a time to perform synchronization and includes information about a date and a time (hour, minute, second, etc.) reserved for synchronization.

Meanwhile, the first content information is information that contains content to be synchronized with a smart device 30 stored in the selected storage box 210 of the storage device 20 and includes any one or more of first data file information, first application information, and first environmental setting information.

The first data file information is information about a data file to be uploaded to the smart device 30 when synchronization is performed and may include a name of the data file to be uploaded, a size of the data file to be uploaded, and content of the data file to be uploaded.

The first application information is information about an application to be installed in the smart device 30 when synchronization is performed and may include a name of the application to be installed, a size of the application to be installed, and content of the application to be installed.

The first environmental setting information is information for setting environments of the smart device 30 when synchronization is performed and may separately include information about on and off settings of a wireless local area network (WLAN) module, on and off settings of a Bluetooth module, lock and unlock settings of a camera, lock and unlock settings of a smart device screen, or information about a password setting.

Next, second synchronization configuration information is described. Second synchronization configuration information is information input from the input unit 23 of the storage device 20 and includes information required for the corresponding storage device 20 to perform synchronization. In other words, second synchronization configuration information is information that separately contains a target of synchronization and content of synchronization and may include second selection information and second content information.

Here, the second selection information contains information about which one of smart devices 30 stored in multiple storage boxes 210 will be synchronized. In particular, each piece of second synchronization configuration information may have its own unique identification information. Identification information of second synchronization configuration information will be referred to as “sixth identification information” below.

Specifically, the second selection information may include synchronization-purposed second storage box selection information, second port selection information, second smart device selection information, and second reservation time information. Here, the second selection information may include any one or more of synchronization-purposed second storage box selection information, second port selection information, and second smart device selection information.

The synchronization-purposed second storage box selection information contains information about which one of multiple storage boxes 210 will be selected and includes second identification information of a storage box 210 selected for synchronization.

The second port selection information contains information about which one of multiple ports 240 will be selected and includes third identification information of a port 240 selected for synchronization.

The second smart device selection information contains information about which one of multiple smart devices 30 will be selected and includes fourth identification information of a smart device 30 selected for synchronization.

The second reservation time information is information about a time to perform synchronization and includes information about a date and a time (hour, minute, second, etc.) reserved for synchronization.

Meanwhile, the second content information is information that contains content to be synchronized with a smart device 30 stored in the selected storage box 210 of the storage device 20 and includes any one or more of second data file information, second application information, and second environmental setting information.

The second data file information is information about a data file to be uploaded to the smart device 30 when synchronization is performed and may separately include a name of the data file to be uploaded, a size of the data file to be uploaded, and content of the data file to be uploaded.

The second application information is information about an application to be installed in the smart device 30 when synchronization is performed and may separately include a name of the application to be installed, a size of the application to be installed, and content of the application to be installed.

The second environmental setting information is information for setting environments of the smart device 30 when synchronization is performed and may separately include information about on and off settings of a wireless LAN module, on and off settings of a Bluetooth module, lock and unlock settings of a camera, lock and unlock settings of a smart device screen, or information about a password setting. Second synchronization configuration information is described. Second synchronization configuration information is information set by the server 10 and includes information required for a storage device 20 receiving the second synchronization configuration information to perform synchronization. In other words, second synchronization configuration information is information that separately contains a target of synchronization and content of synchronization and may include second selection information and second content information.

Next, synchronization result information is described. Synchronization result information is information generated by the control unit 25 of the storage device 20 and information about a result of synchronization performed by the storage device 20 according to first synchronization configuration information received from the server 10 or second synchronization configuration information input from the input unit 23. In other words, synchronization result information may include unique synchronization information, synchronization success-failure information, synchronization time information, detailed synchronization failure information, and the like.

The unique synchronization information is information that contains fifth identification information of first synchronization configuration information received by the storage device 20 or sixth identification information of second synchronization configuration information input to the input unit 23.

For example, when the storage device 20 receives first synchronization configuration information having fifth identification information of [0014] from the server 10 and performs synchronization according to the corresponding first synchronization configuration information, the control unit 25 generates [0014], which is the fifth identification information of the corresponding first synchronization configuration information, as unique synchronization information and generates synchronization success-failure information, which is information about a synchronization result.

Also, when the storage device 20 receives second synchronization configuration information having sixth identification information of [0015] from the input unit 23 and performs synchronization according to the corresponding second synchronization configuration information, the control unit 25 generates [0015], which is the sixth identification information of the corresponding second synchronization configuration information, as unique synchronization information and generates synchronization success-failure information, which is information about a synchronization result.

The synchronization success-failure information is log information about a result of synchronization performed according to first synchronization configuration information or second synchronization configuration information and represents whether synchronization has been successfully performed.

For example, the synchronization success-failure information may contain information of “success” or “failure” of synchronization by storage box, port, or smart device.

The synchronization time information may contain information of a synchronization start date and time and a synchronization end date and time by storage box, port, or smart device when synchronization has been successfully performed.

The detailed synchronization failure information includes second identification information of a storage box 210 whose synchronization has failed, third identification information of a port 240 whose synchronization has failed, or fourth identification information of a smart device 30 whose synchronization has failed and may include information about a detailed reason for a synchronization failure by storage box, port, or smart device.

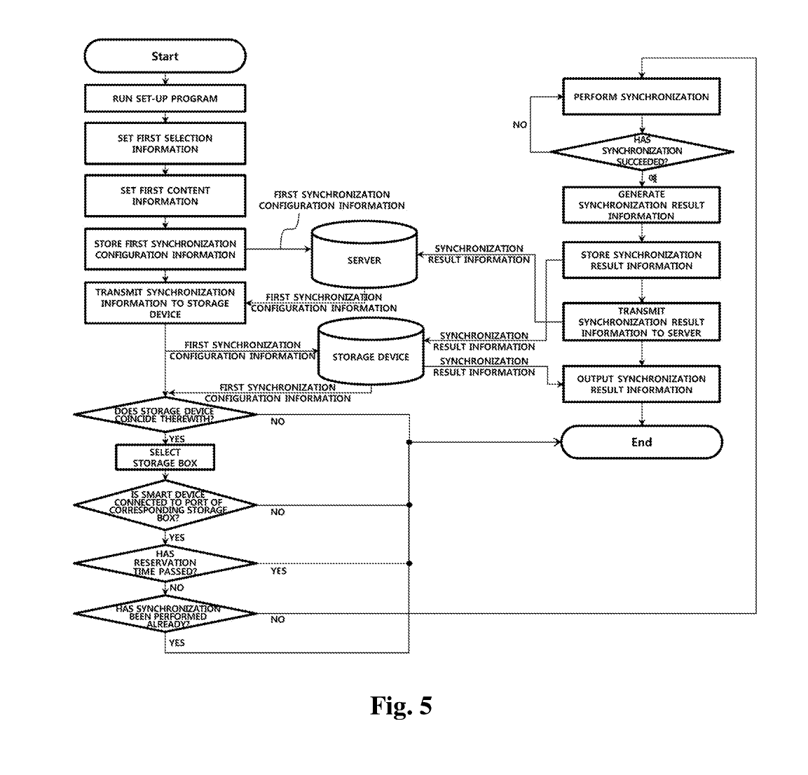

FIG. 5 shows a first embodiment of a data flowchart for synchronization performed by the management system 1 of a smart device according to an embodiment of the present invention.

Embodiments in which the control unit 25 of the storage device 20 performs synchronization will be described below.

First, as a first embodiment, the control unit 25 may perform synchronization according to [Process 1a] to [Process 6a] described below.

[Process 1a]: The control unit 25 determines whether synchronization-purposed storage selection information of first synchronization configuration information received by the communication unit 22 coincides with first identification information of the corresponding storage device 20 and then performs [Process 2a] when the synchronization-purposed storage selection information coincides with the first identification information.

For example, when first identification information of a storage device 20 is [0001], the control unit 25 of the corresponding storage device 20 determines whether first identification information included in synchronization-purposed storage selection information of first synchronization configuration information and performs the following process when the identification information is [0001].

[Process 2a]: The control unit 25 selects ports 240 that coincide with synchronization-purposed first storage box selection information.

For example, when second identification information corresponding to storage box 1 210a, storage box 2 210b, storage box 3 210c, and storage box 5 210e is included in synchronization-purposed first storage box selection information, the control unit 25 selects storage box 1 210a, storage box 2 210b, storage box 3 210c, and storage box 5 210e.

[Process 3a]: The control unit 25 determines whether smart devices 30 have been connected to storage boxes 210 selected in [Process 2a] and then performs [Process 4a] on smart devices 30 whose connections have been confirmed.

For example, it is determined whether smart device 1 30a, smart device 2 30b, smart device 3 30c, and smart device 5 30e have been connected to storage box 1 210a, storage box 2 210b, storage box 3 210c, and storage box 5 210e, respectively. When smart device 1 30a, smart device 2 30b, and smart device 5 30e have been connected and smart device 3 30c has not been connected, the following process is performed on only smart device 1 30a, smart device 2 30b, and smart device 5 30e.

[Process 4a]: The control unit 25 determines whether a time of first reservation time information has passed and then performs [Process 5a] when the time passes.

For example, when a time of first reservation time information is Jul. 17, 2017 2 PM, the control unit 25 waits until Jul. 17, 2017 2 PM.

[Process 5a]: The control unit 25 classifies the smart devices 30 whose connections have been confirmed in [Process 3a] as smart devices 30 which have been previously synchronized according to first content information and non-synchronized smart devices 30. [Process 6a] is performed on only the non-synchronized smart devices 30.

For example, when smart device 5 30e has been previously synchronized according to first content information, the following process is performed on only smart device 1 30a and smart device 2 30b.

[Process 6a]: The control unit 25 synchronizes the non-synchronized smart devices 30 selected in [Process 5a] according to any one or more pieces of information among pieces of information included in received content information, that is, first data file information, first application information, and first environmental setting information.

For example, when first data file information included in the first content information is information about “phone number list data,” first application information is information about “KakaoTalk,” and first environmental setting information is information about “WLAN-off setting,” the control unit 25 uploads phone number list data, installs KakaoTalk, and turns off a WLAN function with respect to each of smart device 1 30a and smart device 2 30b.

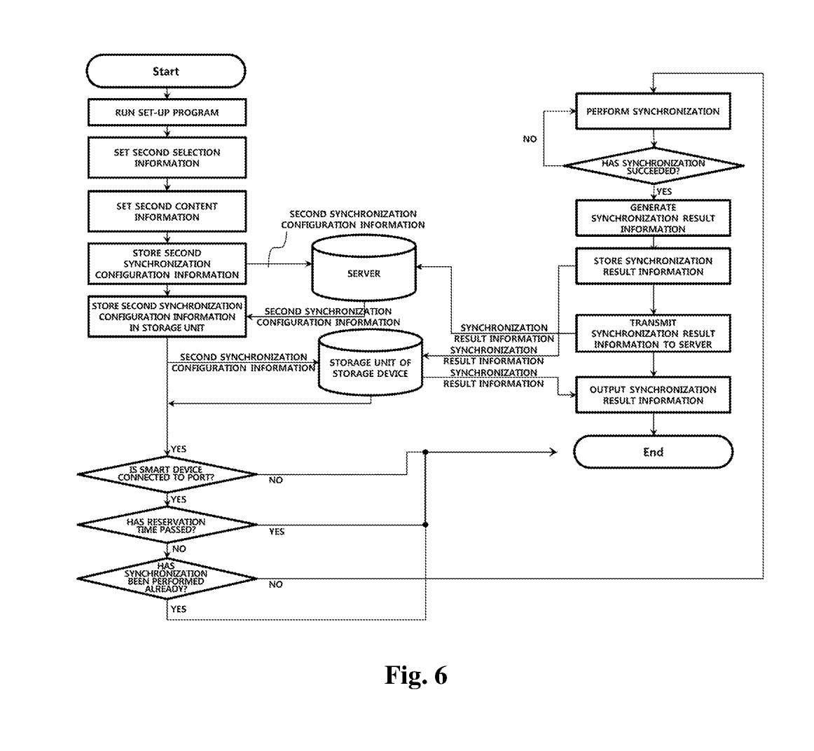

FIG. 6 shows a second embodiment of a data flowchart for synchronization performed by the management system 1 for a smart device according to an embodiment of the present invention.

Next, as a second embodiment, the control unit 25 may perform synchronization according to [Process 1b] to [Process 5b] described below.

[Process 1b]: When second synchronization configuration information is input to the input unit 23, the control unit 25 selects ports 240 that coincide with synchronization-purposed second storage box selection information.

For example, when synchronization-purposed second storage box selection information includes second identification information corresponding to storage box 1 210a, storage box 2 210b, storage box 3 210c, and storage box 5 210e, the control unit 25 selects storage box 1 210a, storage box 2 210b, storage box 3 210c, and storage box 5 210e.

[Process 2b]: The control unit 25 determines whether smart devices 30 have been connected to storage boxes 210 selected in [Process 1b] and then performs [Process 3b] on smart devices 30 whose connections have been confirmed.

For example, it is determined whether smart device 1 30a, smart device 2 30b, smart device 3 30c, and smart device 5 30e have been connected to storage box 1 210a, storage box 2 210b, storage box 3 210c, and storage box 5 210e, respectively. When smart device 1 30a, smart device 2 30b, and smart device 5 30e have been connected and smart device 3 30c has not been connected, the following process is performed on only smart device 1 30a, smart device 2 30b, and smart device 5 30e.

[Process 3b]: The control unit 25 determines whether a time of second reservation time information has passed and then performs [Process 4b] when the time passes.

For example, when a time of second reservation time information is Jul. 17, 2017 2 PM, the control unit 25 waits until Jul. 17, 2017 2 PM.

[Process 4b]: The control unit 25 classifies the smart devices 30 whose connections have been confirmed in [Process 2b] as smart devices 30 which have been previously synchronized according to second content information and non-synchronized smart devices 30. [Process 5b] is performed on only the non-synchronized smart devices 30.

For example, when smart device 5 30e has been previously synchronized according to second content information, the following process is performed on only smart device 1 30a and smart device 2 30b.

[Process 5b]: The control unit 25 synchronizes the non-synchronized smart devices 30 selected in [Process 4b] according to any one or more pieces of information among pieces of information included in received content information, that is, second data file information, second application information, and second environmental setting information.

For example, when second data file information included in the second content information is information about “phone number list data,” second application information is information about “KakaoTalk,” and second environmental setting information is information about “WLAN-off setting,” the control unit 25 uploads phone number list data, installs KakaoTalk, and turns off a WLAN function with respect to each of smart device 1 30a and smart device 2 30b.

A configuration of a set-up program run on the server 10 or the terminal 40, which is connected to the server 10, to set first control information, second control information, or synchronization configuration information will be described below.

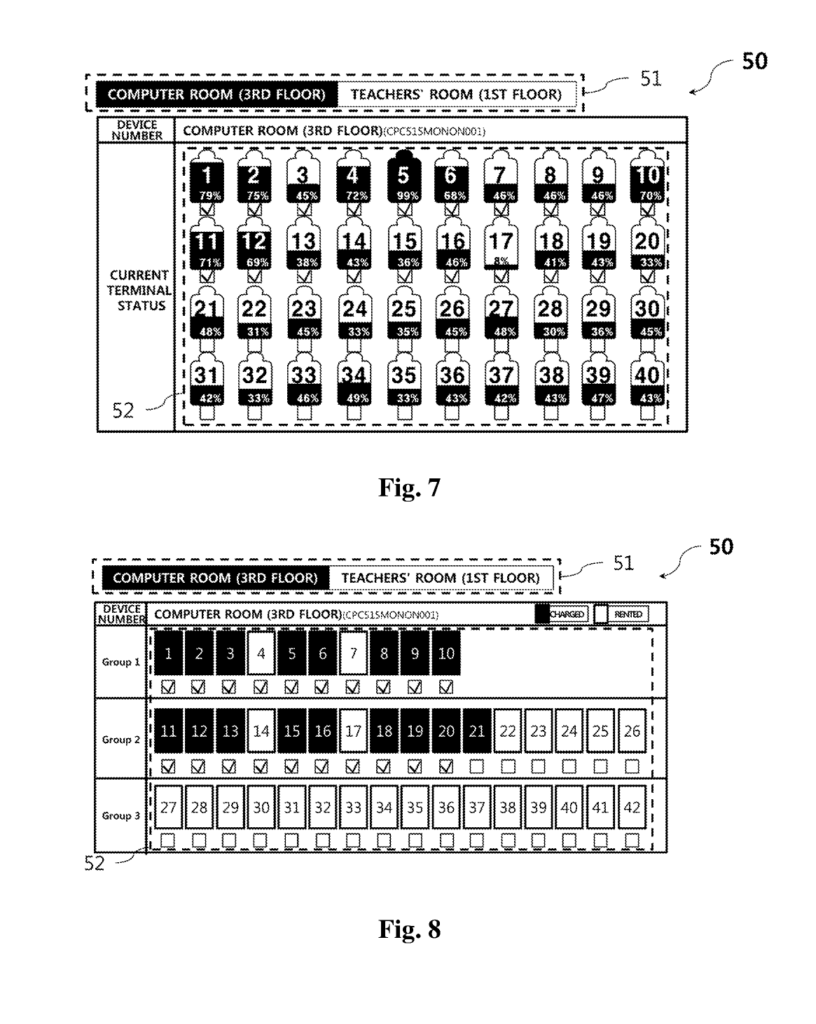

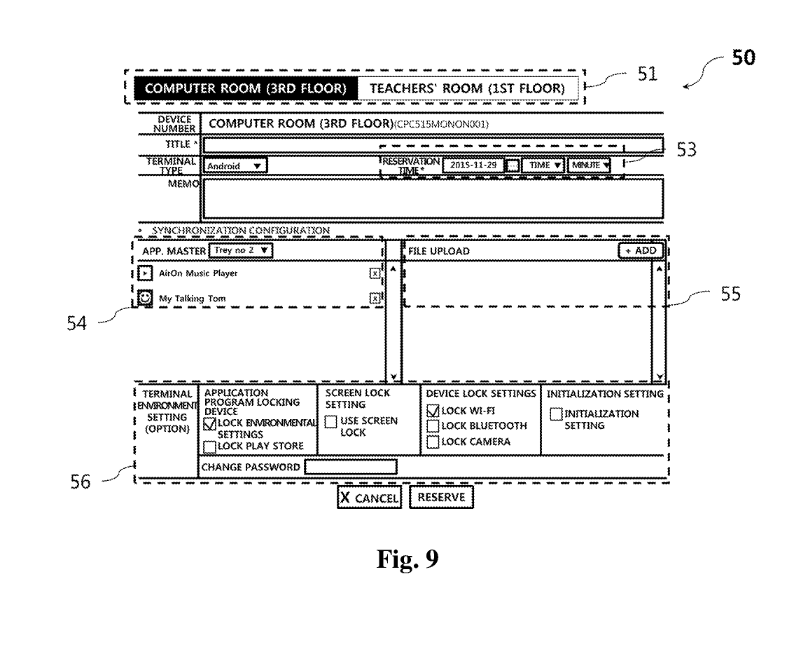

FIGS. 7 to 9 show a set-up program 50 of the management system 1 for a smart device according to an embodiment of the present invention.

The set-up program 50 is implemented as a code which can be interpreted by a computer system in a recording medium which can be read by a computer system, and the recording medium which can be read by a computer system includes any kind of recording medium that stores data which can be read by a computer system.

First control information, second control information, or synchronization configuration information may be set through the set-up program 50. As shown in FIGS. 7 to 9, the set-up program 50 may include a first setting section 51 to a sixth setting section 56.

The first setting section 51 is a component for selecting a storage device 20 which will perform control or synchronization. The first setting section 51 selects control-purposed storage selection information or synchronization-purposed storage selection information in the first control information.

The second setting section 52 is a component for selecting a storage box 210 which will be controlled or synchronized by the storage device 20 selected by the first setting section 51. The second setting section 52 selects control-purposed first storage box selection information in the first control information, control-purposed second storage box selection information in the second control information, synchronization-purposed first storage box selection information in first synchronization configuration information, or synchronization-purposed second storage box selection information in second synchronization configuration information.

The third setting section 53 is a component for selecting a time to perform synchronization. The third setting section 53 sets first reservation time information in the first synchronization configuration information or second reservation time information in the second synchronization configuration information.

The fourth setting section 54 is a component for selecting an application to be installed on a smart device 30. The fourth setting section 54 sets first application information in the first synchronization configuration information or second application information in the second synchronization configuration information.

The fifth setting section 55 is a component for selecting a data file to be uploaded to the smart device 30. The fifth setting section 55 sets first data file information in the first synchronization configuration information or second data file information in the second synchronization configuration information.

The sixth setting section 56 is a component for setting environments of the smart device 30. The sixth setting section 56 sets first environmental setting information in the first synchronization configuration information or second environmental setting information in the second synchronization configuration information.

A management method for a smart device according to an embodiment of the present invention will be described below.

A management method for a smart device according to an embodiment of the present invention employs the smart device system 1 described above with reference to FIGS. 1 to 9 and includes an information receiving operation (S10) and a control operation (S20).

In the information receiving operation (S10), first control information, which is information for selecting and controlling a storage device and a storage box, is transmitted from a server to a storage device, or second control information, which is information for selecting and controlling a storage box, is input to the input unit.

In the control operation (S20), the control unit controls unlocking of a corresponding storage box according to the first control information or the second control information. Also, the management method for a smart device according to an embodiment of the present invention may further include a) operation (S100) to c) operation (S300).

In operation a) (S100), the control unit generates current retaining status information which is information about current utilization status of each storage box.

In operation b) (S200), the communication unit transmits the current retaining status information to the server.

In operation c) (S300), the current retaining status information received by the server is stored in a database, and connection information stored in the database is provided to a terminal which is connected to the server.

Operation a) (S100) may further include an operation (S110) in which the control unit generates current retaining status information according to a locked state or an unlocked state of each storage box sensed by the sensing unit.

The control operation (S20) may further include an operation (S21) in which when first identification information of a corresponding storage device included in storage selection information of the first control information coincides with first identification information stored in the retaining unit, the control unit controls the locking unit so that a storage box corresponding to control-purposed first storage box control information may be unlocked.

Operation a) (S100) may further include an operation (S120) in which when a corresponding storage box is unlocked according to first control information including control-purposed first command information that commands storage of a smart device and then is placed in the locked state again, the control unit generates retaining status information indicating that a smart device is stored in the corresponding storage box, and when a corresponding storage box is unlocked according to first control information including control-purposed first command information that commands removal of a smart device and then is placed in the locked state again, the control unit generates retaining status information indicating that a smart device has been taken out from the corresponding storage box.

The control operation (S20) may further include an operation (S22) in which when second control information is input from the input unit, the control unit controls the locking unit so that a storage box corresponding to control-purposed second storage box selection information may be unlocked.

Operation a) (S100) may further include an operation (S130) in which when a corresponding storage box is unlocked according to second control information including control-purposed second command information that commands storage of a smart device and then is placed in the locked state again, the control unit generates retaining status information indicating that a smart device is stored in the corresponding storage box, and when a corresponding storage box is unlocked according to second control information including control-purposed second command information that commands removal of a smart device and then is placed in the locked state again, the control unit generates retaining status information indicating that a smart device has been taken out from the corresponding storage box.

Operation a) (S100) may further include an operation (S140) in which when the connection unit receives charge information representing charge status from a smart device connected to a port of each storage box, the control unit generates current retaining status information including the charge information.

Operation a) (S100) may further include an operation (S150) in which when no charge information is received by the connection unit or a charge value according to charge information received by the connection unit is maintained within a certain range for a certain time period, the control unit generates current retaining status information including error information that represents an error state of a storage box of a corresponding port.

The control operation (S20) may further include an operation (S23) in which when a smart device is stored or taken out, the control unit controls the imaging unit so that an image may be captured.

The information receiving operation (S10) may further include an operation (S11) in which the server transmits first synchronization configuration information, which is information for selecting and synchronizing a storage device and a storage box, to the storage device, or the input unit receives second synchronization configuration information, which is information for selecting and synchronizing a storage box. In this case, the control operation (S20) may further include an operation (S24) in which the control unit controls the connection unit to synchronize a smart device connected to a port of a corresponding storage box according to the first synchronization configuration information or the second synchronization configuration information.

The control operation (S20) may further include an operation (S25) in which when synchronization-purposed storage selection information included in the first synchronization configuration information coincides with first identification information of the corresponding storage device, the control unit controls the connection unit so that a smart device connected to a port of a storage box corresponding to synchronization-purposed first storage box selection information may be synchronized at a time of first reservation time information according to one or more pieces of information among first data file information, first application information, and first environmental setting information, and when second synchronization configuration information is input through the input unit, the control unit controls the connection unit so that a smart device connected to a port of a storage box corresponding to synchronization-purposed second storage box selection information may be synchronized at a time of second reservation time information according to one or more pieces of information among second data file information, second application information, and second environmental setting information.

In addition, the management method for a smart device according to an embodiment of the present invention may further include operation A (S1000) to operation C (S3000).

In operation A (S1000), the control unit generates synchronization result information, which contains information about results of synchronizing a smart device of a corresponding storage box according to the first synchronization configuration information or the second synchronization configuration information.

In operation B (S2000), the communication unit transmits the synchronization result information to the server.

In operation C (S3000), the server stores the received synchronization result information in the database and provides connection information stored in the database to the terminal which is connected to the server.

The server 10, the storage devices 20, the smart devices 30, the terminal 40, first control information, second control information, first synchronization configuration information, second synchronization configuration information, and synchronization results have been described above with reference to FIGS. 1 to 9, and thus description thereof will be omitted below.

Also, the management method for a smart device according to an embodiment of the present invention may include [Process 1a] to [Process 6a] or [Process 1b] to [Process 5b] described above.

Although the present invention has been described above with reference to embodiments shown in the drawings, the embodiments are provided only to illustrate the present invention, and those of ordinary skill in the technical field to which the present invention pertains will understand that various modifications or equivalents can be derived from the detailed description of the present invention. Therefore, the scope of the present invention should be determined by the technical spirit of the claims.

### INDUSTRIAL APPLICABILITY

The present invention relates to a storage device, a management system, and a management method for a smart device. Since a server can be used to control a storage device, perform synchronization, and provide current retaining status information or synchronization result information by storage box of a storage device, the present invention has industrial applicability in that it is possible to easily store and manage multiple smart devices at a remote place.

1. A storage device for a smart device, the storage device comprising:
a storage unit having multiple storage boxes configured to store smart devices, each storage box being formed as a drawer type which is opened or closed in a sliding manner or a door type having a door which is opened or closed therein;
a communication unit configured to receive, from a server, first control information for selecting a specific storage box and controlling unlocking of the selected storage box and first synchronization configuration information containing information for selecting a specific storage box and synchronizing a smart device stored in the selected storage box and configured to transmit current retaining status information generated by a control unit to the server;
an input unit configured to receive second control information for selecting a specific storage box and controlling unlocking of the selected storage box and second synchronization configuration information containing information for selecting a specific storage box and synchronizing a smart device stored in the selected storage box;
a connection unit configured to be connected to smart devices by having a port connected to a smart device in each storage box and configured to transfer a signal for charging or synchronizing the smart devices to the smart devices through ports;
a locking unit configured to lock or unlock the storage boxes;
a sensing unit configured to sense a locked state or an unlocked state of the storage boxes; and
the control unit configured to control the locking unit according to the first or second control information so that a corresponding storage box is unlocked, to control the connection unit according to the first or second synchronization configuration information so that a smart device connected to a port of the corresponding storage box is synchronized, and configured to generate current retaining status information representing whether each storage box stores a smart device or is empty because a smart device has been taken out,
wherein when the corresponding storage box is unlocked according to the first or second control information including information that commands storage of a smart device and then is placed in the locked state again, the control unit generates retaining status information indicating that a smart device is stored in the corresponding storage box, and when the corresponding storage box is unlocked according to the first or second control information including information that commands removal of a smart device and then is placed in the locked state again, the control unit generates retaining status information indicating that a smart device has been taken out from the corresponding storage box.

2. The storage device of claim 1, wherein the connection unit receives charge information representing charge status from a smart device connected to a port of each storage box, and
the control unit generates current retaining status information including the charge information.

3. The storage device of claim 2, wherein when no charge information is received by the connection unit or a charge value according to the charge information received by the connection unit is maintained within a certain range for a certain time period, the control unit generates current retaining status information including error information which represents an error state of a storage box of a corresponding port.

4. The storage device of claim 1, further comprising:
an imaging unit configured to film a user,
wherein when a smart device is stored or taken out, the control unit controls the imaging unit so that an image is captured.

5. The storage device of claim 1, further comprising:
a retaining unit configured to separately store first identification information, which is unique identification information of the storage device, and second identification information, which is unique identification information of each storage box,
wherein the first synchronization configuration information includes synchronization-purposed storage selection information containing first identification information, synchronization-purposed first storage box selection information containing second identification information, and first reservation time information containing information about a time to perform synchronization and further includes any one or more pieces of information among first data file information containing information about a data file to be uploaded to a smart device, first application information containing information about an application to be installed on the smart device, and first environmental setting information containing information for setting environments of the smart device, and
the second synchronization configuration information includes synchronization-purposed second storage box selection information containing second identification information and second reservation time information containing information about a time to perform synchronization and further includes any one or more pieces of information among second data file information containing information about a data file to be uploaded to a smart device, second application information containing information about an application to be installed on the smart device, and second environmental setting information containing information for setting environments of the smart device.

6. The storage device of claim 5, wherein when the synchronization-purposed storage selection information included in the first synchronization configuration information coincides with first identification information of the corresponding storage device, the control unit controls the connection unit to synchronize the smart device connected to a port of a storage box corresponding to the synchronization-purposed first storage box selection information at a time of the first reservation time information according to any one or more pieces of information among first data file information, first application information, and first environmental setting information, and
when the second synchronization configuration information is input through the input unit, the control unit controls the connection unit to synchronize the smart device connected to a port of a storage box corresponding to the synchronization-purposed second storage box selection information at a time of the second reservation time information according to any one or more pieces of information among second data file information, second application information, and second environmental setting information.

7. The storage device of claim 1, wherein the storage boxes is configured as a drawer type comprising:
a drawer configured to slide and have an accommodation space for accommodating a smart device; and
a body having a bored space to or from which the drawer is pushed in or pulled out, and
the locking unit comprises:
a bracket configured to be installed in an internal rear side of the body;
a latch configured to have a hooking recess formed on one side and a hinge rotating on one side of the bracket;
a solenoid valve configured to be fixed on one side of the bracket and have a plunger coupled to a rear end of the latch;
a first spring configured to be connected to a front end of the latch so that a rotary force is applied in a direction in which the latch is rotated back about a shaft of the hinge;
a hooking shaft provided behind the drawer to be hooked by the hooking recess; and
a second spring provided on a front side of the bracket to push the drawer unlocked from the latch.

8. The storage device of claim 7, wherein the control unit controls the solenoid valve so that the hooking shaft is unlocked from the hooking recess of the latch.

9. A management system for a smart device, the management system comprising:
a server configured to transmit first control information containing information for selecting and controlling a storage device and a storage box; and
one or more storage devices according to any one of claim 1.

10. The management system of claim 9, wherein the server comprises:
a database configured to store information received from the storage devices; and
a server control unit configured to provide the information stored in the database to a terminal connected to the server.

11. A management method for a smart device using one or more storage devices each including a storage unit having multiple storage boxes, each of which is formed as a drawer type which is opened or closed in a sliding manner or a door type having a door which is opened or closed therein, a connection unit configured to be connected to smart devices by having a port connected to a smart device in each storage box and transfer a signal for charging or synchronizing the smart devices to the smart devices through ports, an input unit, a locking unit configured to lock or unlock the storage boxes, a sensing unit configured to sense a locked state or an unlocked state of the storage boxes, and a control unit, the management method comprising:
an information receiving operation of transmitting first control information for selecting a specific storage device and a specific storage box and controlling unlocking of the selected storage box of the selected storage device from a server to the storage device or receiving second control information for selecting a specific storage box and controlling unlocking of the selected storage box through the input unit and of transmitting first synchronization configuration information for selecting a specific storage device and a specific storage box and synchronizing a smart device stored in the selected storage box of the selected storage device from the server to the storage device or receiving second synchronization configuration information for selecting a specific storage box and synchronizing a smart device stored in the selected storage box through the input unit;
a control operation in which the control unit controls the locking unit according to the first or second control information so that a corresponding storage box is unlocked, and the control unit controls the connection unit to synchronize a smart device connected to a port of the corresponding storage box according to the first or second synchronization configuration information;
a generation operation in which the control unit generates current retaining status information representing whether each storage box stores a smart device or is empty because a smart device has been taken out according to the locked state or the unlocked state of the storage box sensed by the sensing unit; and
a transmission operation of transmitting the generated current retaining status information to the server through the communication unit,
wherein the generation operation comprises, when the corresponding storage box is unlocked according to the first or second control information, which commands storage of a smart device, and then is placed in the locked state again, generating retaining status information indicating that a smart device is stored in the corresponding storage box, and when the corresponding storage box is unlocked according to the first or second control information, which commands removal of a smart device, and then is placed in the locked state again, generating retaining status information indicating that a smart device has been taken out from the corresponding storage box.

12. The management method of claim 11, further comprising storing the current retaining status information received by the server in a database and providing connection information stored in the database to a terminal connected to the server.

13. The management method of claim 11, wherein the generation operation further comprises, when the connection unit receives charge information representing charge status from a smart device connected to a port of each storage box, generating current retaining status information including the charge information by the control unit.

14. The management method of claim 13, wherein the generation operation further comprises, when no charge information is received by the connection unit or a charge value according to the charge information received by the connection unit is maintained within a certain range for a certain time period, generating current retaining status information including error information, which represents an error state of a storage box of a corresponding port, by the control unit.

15. The management method of claim 11, wherein the storage devices further includes an imaging unit configured to image a user, and
the control operation further comprises controlling, by the control unit, the imaging unit so that an image is captured when a smart device is stored or taken out.

16. The management method of claim 11, wherein each storage device has first identification information which is unique identification information,
each storage box has second identification information which is unique identification information,
the first synchronization configuration information includes synchronization-purposed storage selection information containing first identification information, synchronization-purposed first storage box selection information containing second identification information, and first reservation time information containing information about a time to perform synchronization and further includes any one or more pieces of information among first data file information containing information about a data file to be uploaded to a smart device, first application information containing information about an application to be installed on the smart device, and first environmental setting information containing information for setting environments of the smart device, and
the second synchronization configuration information includes synchronization-purposed second storage box selection information containing second identification information and second reservation time information containing information about a time to perform synchronization and further includes any one or more pieces of information among second data file information containing information about a data file to be uploaded to a smart device, second application information containing information about an application to be installed on the smart device, and second environmental setting information containing information for setting environments of the smart device.

17. The management method of claim 16, wherein the control operation comprises, when the synchronization-purposed storage selection information included in the first synchronization configuration information coincides with first identification information of the corresponding storage device, controlling, by the control unit, the connection unit to synchronize the smart device connected to a port of a storage box corresponding to the synchronization-purposed first storage box selection information at a time of the first reservation time information according to any one or more pieces of information among first data file information, first application information, and first environmental setting information, and
when the second synchronization configuration information is input through the input unit, controlling, by the control unit, the connection unit to synchronize the smart device connected to a port of a storage box corresponding to the synchronization-purposed second storage box selection information at a time of the second reservation time information according to any one or more pieces of information among second data file information, second application information, and second environmental setting information.

18. The management method of claim 16, further comprising:
generating, by the control unit, synchronization result information containing information about results of synchronizing the smart device of the corresponding storage box according to the first or second synchronization configuration information;
transmitting, by the communication unit, the synchronization result information to the server; and
storing the synchronization result information received by the server in a database and providing connection information stored in the database to a terminal connected to the server.

19. The management method of claim 17, further comprising:
generating, by the control unit, synchronization result information containing information about results of synchronizing the smart device of the corresponding storage box according to the first or second synchronization configuration information;
transmitting, by the communication unit, the synchronization result information to the server; and
storing the synchronization result information received by the server in a database and providing connection information stored in the database to a terminal connected to the server.
